(19) United States
(12) Patent Application Publication
(10) Pub. No.: US 2026/0098169 A1
(43) Pub. Date: Apr. 9, 2026

(54) Ink Jet Ink Composition

(71) Applicant: SEIKO EPSON CORPORATION, Tokyo (JP)

(72) Inventors: Tomohiro ARUGA, Matsumoto (JP); Yuta ASAKAWA, Azumino (JP)

(21) Appl. No.: 19/352,899

(22) Filed: Oct. 8, 2025

(30) Foreign Application Priority Data
Oct. 9, 2024 (JP) 2024-177031

(51) Int. Cl. C09D 11/38; C09D 11/322; C09D 11/328

(52) U.S. Cl. CPC C09D 11/38; C09D 11/322; C09D 11/328

(57) ABSTRACT

The ink jet ink composition of the present disclosure contains a compound A represented by Formula (1) below and water, and has a pH at 25° C. of 7.5 or more. The ink jet ink composition preferably contains a humectant with an HSP value of 15.0 or less. The ink jet ink composition preferably contains a polyol compound having three or more OH groups in the molecule, and the content of the polyol compound in the ink jet ink composition is preferably 1.0% by mass or more.

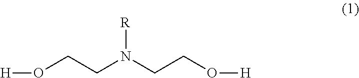

where R is a hydrocarbon group having 6 or more and 12 or less carbon atoms.

The present application is based on, and claims priority from JP Application Serial Number 2024-177031, filed Oct. 9, 2024, the disclosure of which is hereby incorporated by reference herein in its entirety.

### BACKGROUND

### 1. Technical Field

The present disclosure relates to an ink jet ink composition.

### 2. Related Art

As ink, an aqueous ink containing water is widely being used. Since water causes decay, the aqueous ink is required to have antibacterial properties and antifungal properties. In recent years, the use of ink jet printing has expanded, which has been applied to commercial printing, textile printing, and the like in addition to office and household printing machines. Ink jet ink is generally used in an alkaline condition for ejection stability.

Thus, for example, JP-A-2024-54979 discloses an alkaline ink jet ink containing an isothiazolinone-based compound as an antimicrobial agent.

However, while the ink jet ink of JP-A-2024-54979 has antibacterial properties against bacteria, there is a problem in that antifungal properties against fungi are insufficient. Therefore, it is required to provide an ink jet ink composition that is excellent in ejection stability and is also excellent in antibacterial properties against bacteria and antifungal properties against fungi.

### SUMMARY

The present disclosure has been made to solve the above problem, and can be realized as the following application examples.

An ink jet ink composition according to the application examples of the present disclosure contains a compound A represented by Formula (1) below and water, and has a pH at 25° C. of 7.5 or more:

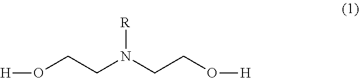

where R is a hydrocarbon group having 6 or more and 12 or less carbon atoms.

### BRIEF DESCRIPTION OF THE DRAWINGS

FIG. 1 is Table 1 showing the configuration of the ink jet ink compositions of Examples 1 to 12.

FIG. 2 is Table 2 showing the configuration of the ink jet ink compositions of Examples 13 to 17 and Comparative Examples 1 to 6.

FIG. 3 is Table 3 showing the evaluation results of the ink jet ink compositions of Examples 1 to 17 and Comparative Examples 1 to 6.

### DESCRIPTION OF EMBODIMENTS

The ink jet ink composition of the present disclosure will be described below based on a preferred embodiment.

### [1] Ink Jet Ink Composition

First, the ink jet ink composition according to the embodiment will be described.

The ink jet ink composition of the present disclosure contains a compound A represented by Formula (1) below and water, and has a pH at 25° C. of 7.5 or more.

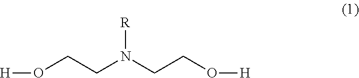

where R is a hydrocarbon group having 6 or more and 12 or less carbon atoms.

Such a configuration can provide an ink jet ink composition that is excellent in ejection stability and is also excellent in antibacterial properties against bacteria and antifungal properties against fungi.

More specifically, the compound A is excellent in antibacterial properties against bacteria and antifungal properties against fungi even in an alkaline solution. Therefore, the ink jet ink composition containing the compound A can also have antibacterial properties against bacteria and antifungal properties against fungi in an alkaline solution. In addition, since the ink jet ink composition is alkaline, an ink jet ink composition that is also excellent in ejection stability can be provided.

The excellent effects as described above are obtained by satisfying all the conditions described above, and the excellent effects as described above are not obtained when any one of the conditions described above is not satisfied.

For example, when the compound A is not used, the antibacterial properties against bacteria and the antifungal properties against fungi of the ink jet ink composition decrease. In addition, when another compound is used instead of the compound A, both antibacterial properties against bacteria and antifungal properties against fungi are not exhibited. For example, when isothiazolinone is used instead of the compound A as an antimicrobial agent, antibacterial properties against bacteria are exhibited, but antifungal properties against fungi are not sufficiently obtained.

In addition, when the number of carbon atoms of the hydrocarbon group represented by R is less than the above lower limit value, the hydrophobicity of the R moiety becomes insufficient, and the antibacterial properties and the antifungal properties of the ink jet ink composition decrease. On the other hand, when the number of carbon atoms of the hydrocarbon group represented by R exceeds the above upper limit value, the compound A is less likely to enter cells, and antibacterial action and antifungal action are less likely to be exhibited.

In addition, when the pH of the ink jet ink composition is less than the above lower limit value, the solubility and dispersibility of a coloring material and a resin contained in the ink jet ink composition decrease. This decreases the ejection stability of the ink jet ink composition.

In the present disclosure, the pH (hydrogen ion exponent) refers to a value determined by a method according to JIS Z 8802. The pH in the present specification is a measured value at 25° C.

The constituent components of the ink jet ink composition of the present disclosure will be described below in detail.

### [1-1] Antimicrobial Agent

The ink jet ink composition of the present disclosure contains the compound A of Formula (1) above as an antimicrobial agent. R in Formula (1) above is a hydrocarbon group having 6 or more and 12 or less carbon atoms. The compound A enters cells by the hydrophobic R moiety having the hydrocarbon group, and exhibits antibacterial action and antifungal action.

The hydrocarbon group represented by R has 6 or more and 12 or less carbon atoms, and preferably has 7 or more and 10 or less carbon atoms, and more preferably has eight carbon atoms. This increases the hydrophobicity of the R moiety, and facilitates entry of the compound A into the cells. Therefore, it is possible to make the antibacterial properties and the antifungal properties of the ink jet ink composition even better. In addition, the solubility of the compound A in water is improved, which provides suitable use as an ink jet ink.

The hydrocarbon group represented by R may have a cyclic hydrocarbon or may have a chain hydrocarbon. In the case of having a chain hydrocarbon, the chain hydrocarbon may have a branched chain, but is preferably linear. This facilitates entry of the compound A into the cells.

The hydrocarbon group represented by R preferably does not have a multiple bond. By not having a multiple bond, the stability of the ink jet ink composition can be improved.

As the compound A satisfying the conditions described above, N-octyldiethanolamine is particularly preferable.

The content of the compound A in the ink jet ink composition is not particularly limited, and is preferably 100 ppm or more and 1,000 ppm or less, more preferably 250 ppm or more and 950 ppm or less, and even more preferably 400 ppm or more and 900 ppm or less. This can achieve both the antibacterial properties and the antifungal properties of the ink jet ink composition and the solubility of the compound A in water at a higher level.

### [1-2] Water

The ink jet ink composition of the present disclosure contains water. Water functions as a solvent for dissolving the compound A. In addition, water functions as a solvent or dispersion medium also for the components described below.

The content of water in the ink jet ink composition is not particularly limited, and is preferably 50% by mass or more and 90% by mass or less, and more preferably 60% by mass or more and 85% by mass or less. This can make the storage stability and the ejection stability of the ink jet ink composition particularly excellent. In addition, when the coloring material described below is contained, it is possible to make the density of an image formed using the ink jet ink composition particularly high.

### [1-3] Humectant

The ink jet ink composition of the present disclosure preferably contains a humectant with an HSP value of 15.0 or less. The compound A contains the hydrocarbon group in the R moiety, and has low solubility in water. Therefore, when the ink jet ink composition contains the humectant with an HSP value of 15.0 or less, the solubility of the compound A in the ink can be improved.

Here, “HSP value” means a three-dimensional solubility parameter value of Hansen represented by Expression (1) below. In the present disclosure, the notation of the unit is omitted, and the unit is (cal/cm³)^{0.5}. The HSP value can be obtained by, for example, referring to the numerical values of δD, δp, and δh in the International Chemical Identifier database and calculating using Expression (1).

$$HSP value = {( δ D 2 + δ P 2 + δ H 2 )}^{0.5} / 4.186 {8}^{0.5} \qquad ( 1 )$$

the dispersion term δD: energy due to intermolecular dispersion force
the polarity term δP: energy due to intermolecular dipole interaction
the hydrogen-bonding term δH: energy due to intermolecular hydrogen bond

The HSP value of such a humectant contained in the ink jet ink composition is preferably 5.0 or more and 15.0 or less, and more preferably 8.0 or more and 14.5 or less. This can further improve the solubility of the compound A in the ink.

The humectant with an HSP value of 15.0 or less is not particularly limited, and examples thereof include alkanediols, glycol monoethers, and amides. Specific examples of alkanediols include propylene glycol, diethylene glycol, triethylene glycol, 1,2-hexanediol, and 1,3-butylene glycol; specific examples of glycol monoethers include triethylene glycol monobutyl ether and triethylene glycol monomethyl ether; and specific examples of amides include 1-(2-hydroxyethyl)-2-pyrrolidone, ε-caprolactam, and 2-pyrrolidone. Among these, propylene glycol is preferable as the humectant with an HSP value of 15.0 or less.

The content of the humectant with an HSP value of 15.0 or less in the ink jet ink composition is preferably 0.1% by mass or more and 35.0% by mass or less, more preferably 1.0% by mass or more and 30.0% by mass or less, and even more preferably 3.0% by mass or more and 25.0% by mass or less. This can further improve the solubility of the compound A in water. Note that when a plurality of kinds of humectants having an HSP value of 15.0 or less are contained in the ink jet ink composition, the sum of the contents is preferably included in the above range.

### [1-4] Polyol Compound

The ink jet ink composition of the present disclosure preferably contains a polyol compound having three or more OH groups in the molecule.

The polyol compound prevents drying of a nozzle or the like that ejects the ink jet ink composition, and improves ejection stability. On the other hand, however, the polyol compound serves as a nutrient source for bacteria and/or fungi, and causes the ink jet ink composition to decay. Since the ink jet ink composition of the present disclosure has antibacterial properties and antifungal properties, decay can be prevented even when the polyol compound is contained. Therefore, when the polyol compound is contained in the ink jet ink composition, sufficient antibacterial properties and antifungal properties can be maintained while enhancing ejection stability.

The polyol compound is not particularly limited, and examples thereof include glycerin, sorbitol, diglycerin, polyglycerin, mannitol, xylitol, erythritol, lactitol, maltitol, galactitol, and trehalose. Among these, glycerin and sorbitol are preferable as the polyol compound.

The content of the polyol compound in the ink jet ink composition is preferably 1.0% by mass or more, more preferably 5.0% by mass or more and 30.0% by mass or less, and even more preferably 10.0% by mass or more and 25.0% by mass or less. This can further enhance ejection stability while maintaining sufficient antibacterial properties and antifungal properties. Note that when a plurality of kinds of polyol compounds are contained in the ink jet ink composition, the sum of the contents is preferably included in the above range.

### [1-5] pH Adjuster

### [1-5-1] Acidic pH Adjuster

The compound A contained in the ink jet ink composition of the present disclosure exhibits strong alkalinity. Therefore, the ink jet ink composition of the present disclosure preferably contains an acidic pH adjuster, and more preferably contains an organic acid. This can more appropriately adjust the pH of the ink jet ink composition and make the antibacterial properties and the antifungal properties even better.

Examples of the organic acid include carboxylic acids such as adipic acid, citric acid, succinic acid, fumaric acid, lactic acid, tartaric acid, and gluconic acid.

The content of the organic acid in the ink jet ink composition is preferably 0.05% by mass or more and 3.0% by mass or less, and more preferably 0.1% by mass or more and 2.0% by mass or less. This can more appropriately adjust the pH of the ink jet ink composition. Note that when a plurality of kinds of organic acids are contained in the ink jet ink composition, the sum of the contents is preferably included in the above range.

### [1-5-2] Alkaline pH Adjuster

The ink jet ink composition may contain an alkaline pH adjuster. In particular, it is preferably used in combination with the acidic pH adjuster. This can more appropriately adjust the pH of the ink jet ink composition. Note that the alkaline pH adjuster does not include the compound A.

Examples of the alkaline pH adjuster include alkanolamines other than the compound A, hydroxides of alkali metals, carbonates of alkali metals, and aminosulfonic acids. More specifically, examples thereof include the following compounds. Examples of alkanolamines other than the compound A include diethanolamine, dimethylethanolamine, diethylethanolamine, triethanolamine, and triisopropanolamine. Examples of hydroxides of alkali metals include lithium hydroxide, sodium hydroxide, potassium hydroxide, and ammonium hydroxide. Examples of carbonates of alkali metals include lithium carbonate, sodium carbonate, and potassium carbonate. Examples of aminosulfonic acids include taurine.

The content of the alkaline pH adjuster in the ink jet ink composition is preferably 0.05% by mass or more and 3.0% by mass or less, and more preferably 0.1% by mass or more and 2.0% by mass or less. This can more appropriately adjust the pH of the ink jet ink composition. Note that when a plurality of kinds of alkaline pH adjusters are contained in the ink jet ink composition, the sum of the contents is preferably included in the above range.

When the content of the alkaline pH adjuster is XA (% by mass) and the content of the compound A is XB (% by mass), XB/XA is preferably 0.05 or more and 0.50 or less, more preferably 0.08 or more and 0.45 or less, and even more preferably 0.10 or more and 0.40 or less. This can more appropriately adjust the pH of the ink jet ink composition and make the antibacterial properties and the antifungal properties thereof even better.

### [1-6] Coloring Material

The ink jet ink composition of the present disclosure preferably contains a coloring material. With this, the ink jet ink composition can be suitably used for forming an image described below.

As the coloring material, for example, various dyes and various pigments can be used. Examples of dyes include disperse dyes, reactive dyes, and acid dyes. Examples of disperse dyes include Disperse Red 60. Examples of reactive dyes include Reactive Orange 13. Examples of acid dyes include Acid Yellow 79 and Acid Yellow 95. Examples of pigments include Pigment Red 122 and Pigment Blue 15:3. Further, although not particularly limited, for example, various dyes and various pigments described in Color Index can be used.

The ink jet ink composition of the present disclosure preferably contains one or more selected from a reactive dye and a coloring material containing a chlorine atom in the molecule. The reactive dye and the coloring material containing a chlorine atom in the molecule have a function of corroding metal members. Therefore, it is necessary to take measures against rust during use. The ink jet ink composition of the present disclosure has a rust prevention effect by containing the compound A. Therefore, when at least one of the reactive dye and the coloring material containing a chlorine atom in the molecule is contained in the ink jet ink composition, the effects of the present disclosure can be enhanced.

Examples of the coloring material containing a chlorine atom in the molecule include Reactive Orange 13 and Reactive Blue 49.

In addition, the ink jet ink composition may contain a metal-free coloring material. A metal-containing coloring material containing a metal has antibacterial properties and antifungal properties in itself. On the other hand, since the metal-free coloring material does not have antibacterial properties or antifungal properties, it easily decays as compared with the metal-containing coloring material. Since the ink jet ink composition of the present disclosure is excellent in antibacterial properties and antifungal properties, even when the metal-free coloring material, which tends to be inferior in antibacterial properties and antifungal properties when added to the ink jet ink composition, is contained, decay can be inhibited. Therefore, the effects of the present disclosure can be maintained even with an ink jet ink composition containing the metal-free coloring material. In addition, not containing the metal-containing coloring material is preferable. Not containing the metal-containing coloring material means that the metal-containing coloring material is not substantially contained in the ink jet ink composition, and the content of the metal-containing coloring material is preferably 0.5% by mass or less, more preferably 0.3% by mass or less, and even more preferably 0.1% by mass or less.

Examples of the metal-free coloring material include Disperse Red 60, Reactive Orange 13, Acid Yellow 79, and Pigment Red 122. Examples of the metal-containing coloring material include Pigment Blue 15:3.

The content of the coloring material in the ink jet ink composition of the present disclosure is preferably 0.1% by mass or more and 20.0% by mass or less, and more preferably 0.2% by mass or more and 15.0% by mass or less. When the content of the coloring material is a value within the above range, it is possible to achieve both ejection stability by an ink jet method and the density of an image formed by the ink jet ink composition at a higher level. Note that when the ink jet ink composition contains a plurality of kinds of coloring materials, the sum of their contents is preferably included in the above range.

### [1-7] Other Components

The ink jet ink composition may contain components other than those described above. Such components will also be referred to as “other components” below in this section.

Examples of the other components include chelating agents, preservatives other than those described above, flame retardants, various dispersants, resins, rust inhibitors other than those described above, antioxidants, ultraviolet absorbers, oxygen absorbers, dissolution aids, penetrants, antifoaming agents, surfactants, and coloring materials other than those described above.

Examples of chelating agents include an ethylenediamine tetraacetate. Examples of preservatives include sodium benzoate, sodium pentachlorophenol, sodium 2-pyridinethiol-1-oxide, sodium sorbate, sodium dehydroacetate, 1,2-dibenzoisothiazolin-3-one, and 4-chloro-3-methylphenol.

Examples of resins include styrene-acrylic resins, polyethylene waxes, and vinyl chloride-vinyl acetate-based copolymer resins. When the ink jet ink composition contains a resin, the fixability of the ink jet ink composition to a recording medium described below can be enhanced.

Examples of ultraviolet absorbers include benzophenone-based compounds, cinnamic acid-based compounds, triazine-based compounds, stilbene-based compounds, and so-called fluorescent brighteners (compounds that absorb ultraviolet light and emit fluorescence, represented by benzoxazole-based compounds).

Examples of antifoaming agents include highly oxidized oil-based compounds, glycerin fatty acid ester-based compounds, fluorine-based compounds, silicone-based compounds, and acetylene-based compounds.

As surfactants, for example, various surfactants such as anionic surfactants, cationic surfactants, and nonionic surfactants can be used. Examples of nonionic surfactants include silicone-based surfactants and acetylene glycol-based surfactants.

The content of the other components in the ink jet ink composition of the present disclosure is preferably 10.0% by mass or less, and more preferably 5.0% by mass or less.

### [1-8] Other Conditions

As described above, the pH of the ink jet ink composition of the present disclosure is 7.5 or more, and is preferably 7.7 or more and 11.0 or less, and more preferably 8.0 or more and 10.0 or less. This can more remarkably exhibit the effects of the present disclosure described above.

The surface tension (surface tension at 20° C.) of the ink jet ink composition of the present disclosure is preferably 20 mN/m or more and 50 mN/m or less, and more preferably 25 mN/m or more and 40 mN/m or less. Note that the surface tension of the ink jet ink composition can be determined by, for example, measurement according to JIS K3362 using a surface tension meter CBVP-A3 (manufactured by Kyowa Interface Science Co., Ltd.).

The viscosity (viscosity at 20° C.) of the ink jet ink composition of the present disclosure is preferably 2 mPa-s or more and 20 mPa-s or less. This can make the ejection stability (the stability of an ejection amount, the flight characteristics of liquid droplets, and the like), ejection responsiveness (response speed, high-frequency responsiveness (frequency characteristics), and the like), and the like of the ink jet ink composition particularly excellent. Note that the viscosity of the ink jet ink composition can be determined by measurement according to JIS Z8809 using a vibration type viscometer.

### [2] Recording Method

Next, an example of the recording method according to the present disclosure will be described. The recording method includes a step of ejecting the ink jet ink composition of the present disclosure by an ink jet method and attaching the ink jet ink composition to a recording medium. The ink jet ink composition of the present disclosure is excellent in ejection stability, and is also excellent in antibacterial properties against bacteria and antifungal properties against fungi. Therefore, by using the ink jet ink composition of the present disclosure, it is possible to provide a recording method capable of stably producing a recorded matter that is excellent in antibacterial properties against bacteria and antifungal properties against fungi.

In the recording method according to the present disclosure, the ink jet ink composition of the present disclosure is ejected as liquid droplets by an ink jet method, and the liquid droplets are attached to a recording medium. Thus, a desired image is formed. For the formation of the image, a plurality of kinds of ink jet ink compositions, for example, a plurality of kinds of ink jet ink compositions of the present disclosure may be used.

The ink jet method that ejects the ink jet ink composition may be any method, and examples thereof include on-demand methods such as a charge deflection method, a continuous method, a piezoelectric method, and a bubble jet (registered trademark) method.

The recording medium is not particularly limited, and examples thereof include various fabrics, paper such as plain paper, recording media provided with an ink receiving layer that are referred to as exclusive paper for ink jet, coated paper, and the like, and plastic films formed of various plastics such as polyethylene terephthalate and polypropylene.

In the recording method of the present disclosure, not only the ink jet ink composition of the present disclosure but also other ink compositions may be used in combination.

The recording method of the present disclosure may further include other steps in addition to the step described above. Examples thereof include a step of applying a coating layer to the recording medium, a step of heating the recording medium, and a step of cleaning the recording medium.

### [3] Recorded Matter

The recorded matter according to the present disclosure is produced using the ink jet ink composition of the present disclosure described above, and can be produced using the recording method described above. This can provide a recorded matter that is excellent in antibacterial properties against bacteria and antifungal properties against fungi.

Although the preferred embodiments of the present disclosure have been described above, the present disclosure is not limited thereto.

### EXAMPLES

Next, specific examples of the present disclosure will be described, but the present disclosure is not limited thereto. The treatments and measurements in Examples below with no temperature condition shown were carried out at room temperature (25° C.).

### [4] Preparation of Ink Jet Ink Composition

### Example 1

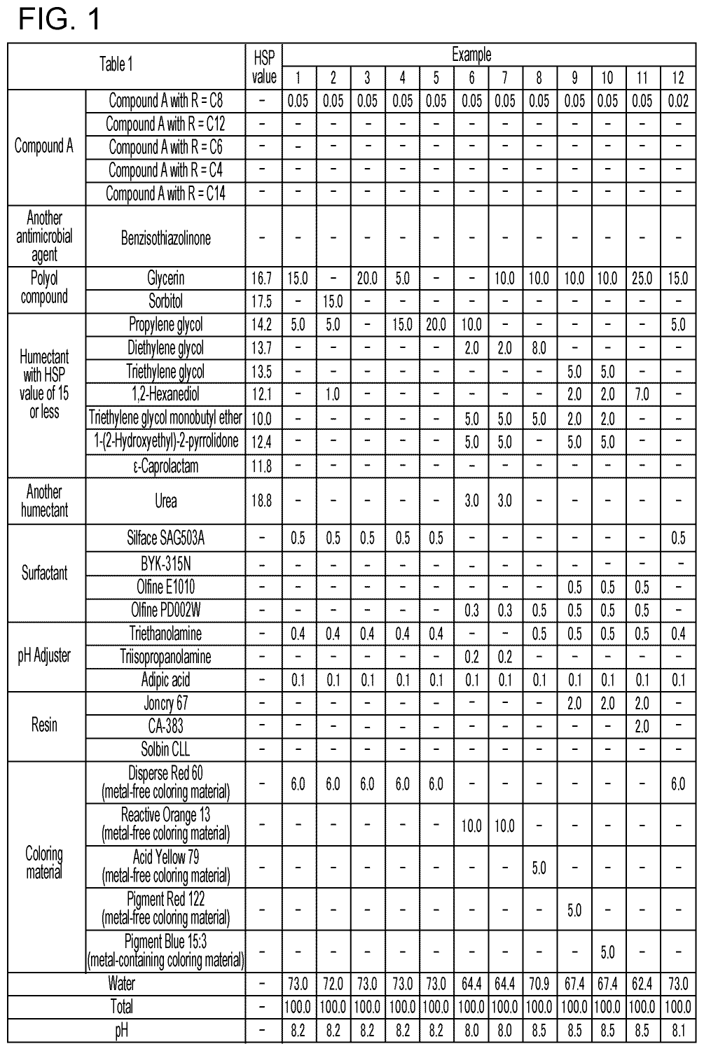

The components were mixed at a predetermined ratio to obtain an ink jet ink composition having the composition shown in FIG. 1.

### Examples 2 to 17

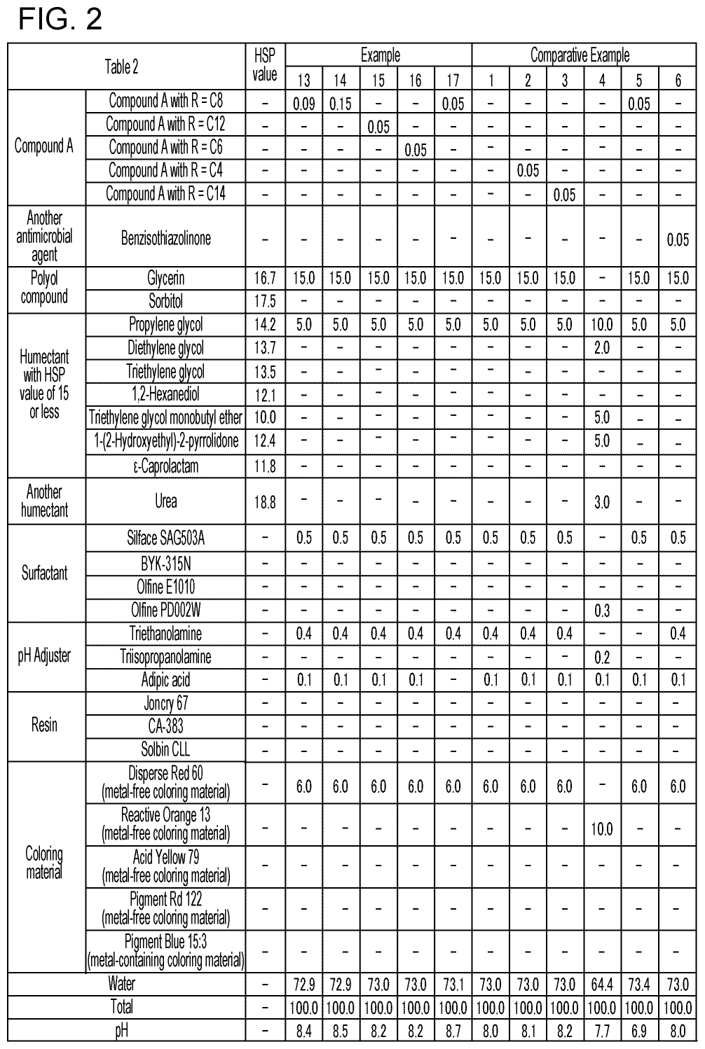

Ink jet ink compositions were prepared in the same manner as in Example 1 described above except that the kinds of the components used in the preparation of the ink jet ink compositions and the blending ratio of each component were changed to have the compositions shown in FIG. 1 and FIG. 2.

### Comparative Examples 1 to 6

Ink jet ink compositions were prepared in the same manner as in Example 1 described above except that the kinds of the components used in the preparation of the ink jet ink compositions and the blending ratio of each component were changed to have the compositions shown in FIG. 2.

FIG. 1 and FIG. 2 collectively show the compositions of the ink jet ink compositions of Examples and Comparative Examples. In the column of the composition in FIG. 1 and FIG. 2, the unit of the numerical value is % by mass, and the column with no description of the numerical value and marked with “−” means not being contained. In the tables, an antimicrobial agent other than the compound A is indicated as “another antimicrobial agent,” and a polyol compound having three or more OH groups in the molecule is indicated as “polyol compound.” In addition, the solid content of Silface SAG503A (trade name, manufactured by Nissin Chemical Co., Ltd.), which is a silicone-based surfactant, is indicated as “Silface SAG503A,” and the solid content of BYK 315N (trade name, manufactured by BYK-Chemie), which is a silicone-based surfactant, is indicated as “BYK 315N.” The solid content of Olfine E1010 (trade name, manufactured by Nissin Chemical Co., Ltd.), which is an acetylene glycol-based surfactant, is indicated as “Olfine E1010,” and the solid content of Olfine PD002W (trade name, manufactured by Nissin Chemical Co., Ltd.), which is an acetylene glycol-based surfactant, is indicated as “Olfine PD002W.” The solid content of Joncryl 67 (trade name, manufactured by BASF), which is resin particles made of a material containing a styrene acrylic resin, is indicated as “Joncryl 67,” the solid content of CA-383 (trade name, manufactured by BASF), which is resin particles made of a material containing a polyethylene wax, is indicated as “CA-383,” and the solid content of Solbin CLL (trade name, manufactured by Nissin Chemical Co., Ltd.), which is resin particles made of a material containing a vinyl chloride-vinyl acetate-based copolymer resin, is indicated as “Solbin CLL.”

### [5] Evaluation of Ink Jet Ink Composition

### [5-1] Solubility

For each of Examples and Comparative Examples, an ink jet ink composition in which the coloring material and the resin were excluded from each composition was prepared, and stirred for 20 minutes with a magnetic stirrer (rotation speed: 200 rpm). Thereafter, the dissolved state of each component was visually checked to evaluate solubility.
A: colorless and transparent
C: cloudiness or separation

### [5-2] Antibacterial Properties (Bacteria)

Into 10 ml of the ink jet ink composition of each of Examples and Comparative Examples, 0.1 mL of a test bacterial solution of Escherichia coli prepared to be 10×10⁸ CFU/mL was inoculated, and left to stand at 25° C. for 24 hours. A 10-fold dilution series of the ink jet ink composition after being left to stand was prepared using an SCDLP liquid medium, smeared and inoculated on a standard agar medium, and cultured at 30° C. for 48 hours. After the culture, a viable bacterial count was calculated based on the number of formed colonies. An initial bacterial count was calculated using the measurement result of the viable bacterial count and the inoculation amount of the test bacterial solution. In each of Examples and Comparative Examples, the measurement was performed three times, and the average value thereof was used as a measurement result to evaluate antibacterial properties according to the following evaluation criteria.
A: viable bacterial count of less than detection limit
B: viable bacterial count of detection limit or more and less than 50% of initial bacterial count
C: viable bacterial count of 50% or more of initial bacterial count

### [5-3] Antifungal Properties (Fungi)

Into 10 ml of the ink jet ink composition of each of Examples and Comparative Examples, 0.1 ml of a test bacterial solution of Penicillium funiculosum prepared to be 10×10⁸ CFU/mL was inoculated, and left to stand at 25° C. for 24 hours. A 10-fold dilution series of the ink jet ink composition after being left to stand was prepared using an SCDLP liquid medium, smeared and inoculated on a standard agar medium, and cultured at 20° C. for 3 days. After the culture, a viable bacterial count was calculated based on the number of formed colonies. An initial bacterial count was calculated using the measurement result of the viable bacterial count and the inoculation amount of the test bacterial solution. In each of Examples and Comparative Examples, the measurement was performed three times, and the average value thereof was used as a measurement result to evaluate antifungal properties according to the following evaluation criteria.
A: viable bacterial count of less than detection limit
B: viable bacterial count of detection limit or more and less than 50% of initial bacterial count
C: viable bacterial count of 50% or more of initial bacterial count

### [5-4] Ejection Stability

An ink cartridge of an ink jet recording apparatus PX-G930 (manufactured by Seiko Epson Corporation) was filled with the ink jet ink composition of each of Examples and Comparative Examples, and it was confirmed that the ink could be ejected from all nozzles. Thereafter, the ink jet recording apparatus was left to stand for 5 days in an environment with a temperature of 40° C. and a humidity of 20% in a state where an ink jet head was displaced from the position of a cap provided in the ink jet recording apparatus, and the head was not capped.

After being left to stand, as the cleaning of the ink jet head, a suction operation of the ink in the nozzles was repeated three times in the order of a suction amount of 4 g, 2 g, and 2 g at room temperature. After the suction operation, ejection stability was evaluated according to the following evaluation criteria based on the number of nozzles recovered without non-ejection.
A: no unrecovered nozzles
B: 1 or more and 10 or less unrecovered nozzles
C: 11 or more unrecovered nozzles

### [5-5] Rust Preventiveness

A test and grade determination according to “Method for Measuring Degree of Rust Occurrence” described in JIS K2246: 2018 “Rust Prevention Oil” were performed. Note that the environmental conditions included a temperature of 80° C., a humidity of 95%, and 10 days.
A: Grades A to D
C: Grade E

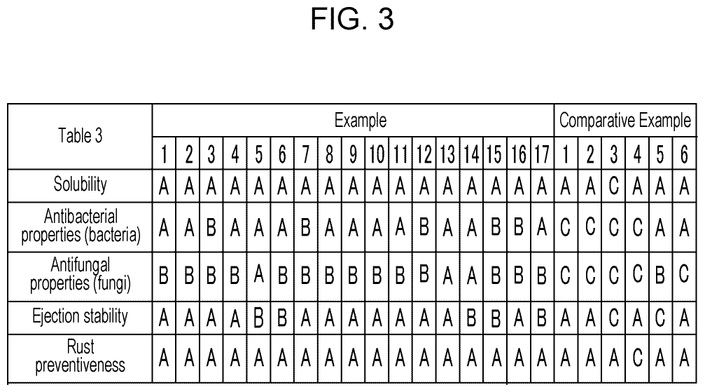

FIG. 3 collectively shows these evaluation results.

As is clear from FIG. 3, the ink jet ink composition of each of Examples was excellent in solubility, antibacterial properties against bacteria, antifungal properties against fungi, ejection stability, and rust preventiveness. In contrast, no satisfactory result was obtained with the ink jet ink composition of each of Comparative Examples.

What is claimed is:

1. An ink jet ink composition comprising:
a compound A represented by Formula (1) below; and
water, having a pH at 25° C. of 7.5 or more: 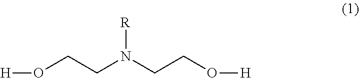
where R is a hydrocarbon group having 6 or more and 12 or less carbon atoms.

2. The ink jet ink composition according to claim 1, further comprising a humectant with an HSP value of 15.0 or less.

3. The ink jet ink composition according to claim 1, further comprising a polyol compound having three or more OH groups in a molecule, wherein a content of the polyol compound in the ink jet ink composition is 1.0% by mass or more.

4. The ink jet ink composition according to claim 1, wherein R is a hydrocarbon group having eight carbon atoms.

5. The ink jet ink composition according to claim 1, wherein a content of the compound A in the ink jet ink composition is 100 ppm or more and 1,000 ppm or less.

6. The ink jet ink composition according to claim 1, further comprising an organic acid.

7. The ink jet ink composition according to claim 1, further comprising a coloring material.

8. The ink jet ink composition according to claim 7, wherein the coloring material includes a metal-free coloring material.

9. The ink jet ink composition according to claim 7, wherein the coloring material includes one or more selected from a reactive dye and a coloring material containing a chlorine atom in a molecule.
